(19) United States
(12) Patent Application Publication
(10) Pub. No.: US 2022/0200126 A1
(43) Pub. Date: Jun. 23, 2022

(54) ROTATABLE HOUSING ASSEMBLIES FOR CAMERAS AND ANTENNAS

(71) Applicant: Hewlett-Packard Development Company, L.P., Spring, TX (US)

(72) Inventors: Paul Roberto Lalinde, Spring, TX (US); Gary D. Walker, Spring, TX (US)

(73) Assignee: Hewlett-Packard Development Company, L.P., Spring, TX (US)

(21) Appl. No.: 17/606,079

(22) PCT Filed: Jul. 26, 2019
(86) PCT No.: PCT/US2019/043749

§ 371 Date: Oct. 25, 2021

(51) Int. Cl. H01Q 1/08; H04N 5/225

(52) U.S. Cl. CPC H01Q 1/084; H04N 5/2258; H04N 5/2252

(57) ABSTRACT

According to examples, an apparatus may include a housing assembly, a camera, and an antenna. The housing assembly may include a first portion that may be rotatably coupled to an electronic device and a second portion that may be rotatably coupled to the first portion. The second portion may have a columnar shape and a cavity may be formed in the second portion. The camera and the antenna may be disposed in the cavity formed in the second portion of the housing assembly.

### BACKGROUND

Electronic devices may support many different functions and various components may be incorporated into the electronic devices to perform the functions. The components of the electronic devices, such as cameras, may be statically housed in casings for the electronic devices.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may include a housing assembly for a camera and an antenna;

FIG. 2A shows a diagram of an example electronic device in which the example apparatus depicted in FIG. 1 may be implemented;

FIG. 2B shows a diagram of a housing assembly of the example apparatus depicted in FIGS. 1 and 2A;

FIG. 3 shows an enlarged cross-sectional view of a portion of the example electronic device depicted in FIG. 2A; and

FIG. 4 shows a cross-sectional view of the example apparatus depicted in FIGS. 1, 2A, and 2B.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Electronic devices such as computer monitors, laptop computers, tablet computers, and/or mobile phones may support increasing numbers of functions and each of the functions may use different components to support those functions. In addition to the implementation of various functions and features, electronic devices are continuously being re-designed to reduce their form factors. Accordingly, spaces inside casings of the electronic devices may be limited. Furthermore, certain components, such as cameras, antennas, or the like, may be disposed outside the casings for proper operation of certain functions.

Disclosed herein are apparatuses that may integrate a camera and an antenna in a single housing assembly. The housing assembly may be movably mounted on an electronic device. In some examples, the housing assembly may be positioned outside the casing of the electronic device when in use, and inserted into the casing and hidden when not in use. Furthermore, the housing assembly may be rotatable and/or bendable about multiple axes, which may facilitate focusing of the camera and/or movement of the antenna at any desired position both rotational and angular. By combining the camera and antenna into the movable housing assembly, the amount of space consumed by the camera and the antenna may be reduced while providing flexibility in the directions in which the camera and the antenna may be directed. In other words, the apparatus of the present disclosure also allows concealment when not in use as well as improved movement/positioning of the camera and the antenna. Furthermore, in some implementations, multiple housing assemblies may be mounted to an electronic device. The multiple housing assemblies may facilitate three-dimensional (3D) image capture for partial 3D rendering of an object.

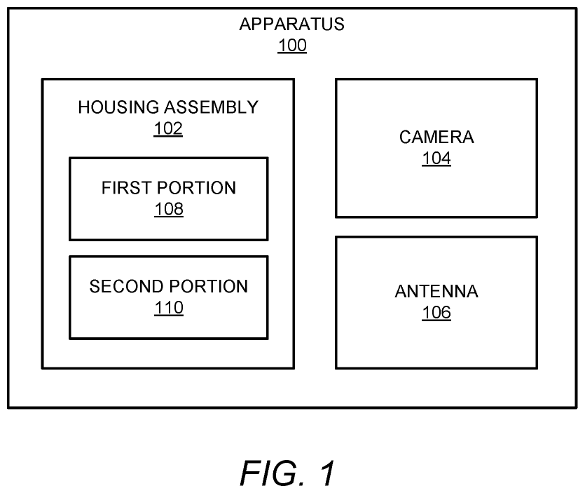

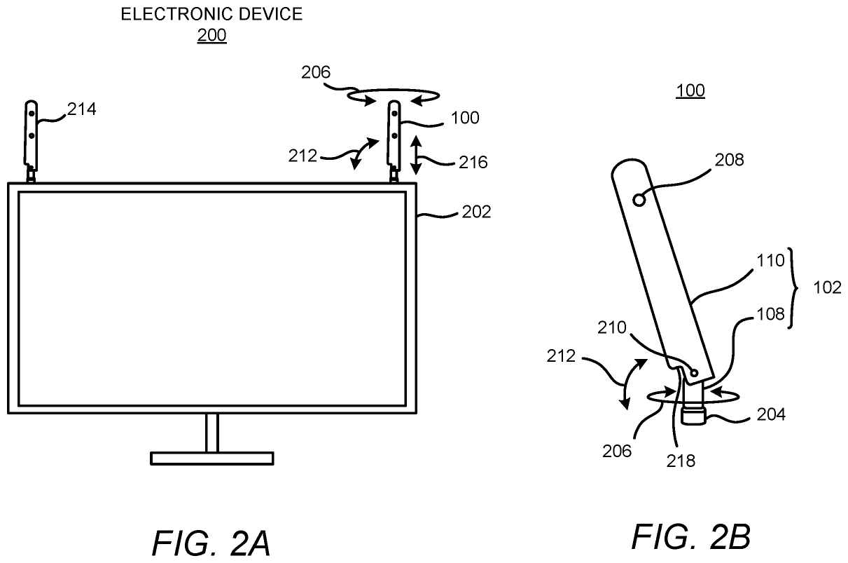

Reference is first made to FIGS. 1, 2A, and 2B. FIG. 1 shows a block diagram of an example apparatus 100 that may include a housing assembly for a camera and an antenna. FIG. 2A shows a diagram of an example electronic device 200 in which the example apparatus 100 depicted in FIG. 1 may be implemented and FIG. 2B shows a diagram of a housing assembly 102 of the example apparatus 100 depicted in FIGS. 1 and 2A. It should be understood that the example apparatus 100 depicted in FIGS. 1 and 2B and the example electronic device 200 depicted in FIG. 2A may include additional features and that some of the features described herein may be removed and/or modified without departing from the scopes of the apparatus 100 and/or the electronic device 200.

The apparatus 100 may include a housing assembly 102 within which a camera 104 and an antenna 106 may be mounted. The housing assembly 102 may be mounted to the electronic device 200 and may facilitate movement of the camera 104 and the antenna 106 relative to a casing 202 of the electronic device 200. In order to allow the housing assembly 102 to be movably mounted, the housing assembly 102 may include a first portion 108 and a second portion 110 as described below.

The first portion 108 of the housing assembly 102 may be connected to the electronic device 200 and may function as a base to support the second portion 110. The first portion 108 may include a connector 204 by which the first portion 108 may be physically mounted on the electronic device 200. The connector 204 may be one of various types of connectors that may facilitate either or both physical mounting as well as electrical connection for the camera 104 and the antenna 106. In some examples, the connector 204 may be removable so that the housing assembly 102 may easily be separated from the electronic device 200. For example, the connector 204 may have one of various types of connection interfaces such as a screw-type coupling mechanism, a quick connect/disconnect coupling mechanism (e.g., bayonet lugs and coupling nut), or another appropriate type of connection interface.

In some examples, the first portion 108 may be rotatable relative to the electronic device 200, as denoted by the arrow 206. For instance, the first portion 108 may be rotatable at the connector 204 while the connector 204 is mounted to the electronic device 200. In a particular example, one end of the connector 204 may be mounted to the electronic device 200 and the other end may be rotatably coupled to the first portion 108. The first portion 108 may be rotatable bi-directionally about a first axis (e.g., a vertical axis), which may facilitate rotation of the second portion 110 of the housing assembly 102 about the first axis.

In some examples, the first portion 108 may have a columnar shape having a cavity formed therein. For example, a casing or outer surface of the first portion 108 may be round and elongated in a tubular shape. The inside of the first portion 108 may be hollow to accommodate data connections to the camera 104 and the antenna 106.

The second portion 110 of the housing assembly 102 may be coupled to the first portion 108. In order to accommodate the camera 104 and the antenna 106, the second portion 110 may have a cavity formed inside the outer casing of the second portion 110. The outer casing (which may equivalently be termed an enclosure), may have a columnar shape and the cavity may be formed in the outer casing. For example, the casing or outer surface of the second portion 110 may be rounded and elongated in a tubular shape. The cavity formed inside the second portion 110 may also be elongated, which may facilitate mounting of the camera 104 and the antenna 106 within the cavity formed inside the second portion 110.

The second portion 110 may have a length that is longer than a length of the first portion 108 to have an elongated, tubular shape, which may facilitate positioning of the camera 104. For instance, the camera 104 may be mounted toward a distal end of the second portion 110, which may facilitate a relatively large range of motion of the camera 104.

In some examples, an opening 208 (or hole) may be formed through the casing of the second portion 110 to accommodate a camera lens. The opening 208 may be positioned at the distal end of the second portion 110 and may have a round shape, or another appropriate shape depending on the camera 104 or the camera lens. The camera 104 may be installed at the opening 208 of the second portion 110 such that the camera lens may be flush or substantially flush with the outer surface of the second portion 110. In other examples, however, the camera lens may extend below or beyond the outer surface of the second portion 110.

The elongated shape of the second portion 110 may also facilitate the arrangement of the antenna 106 in the second portion 110. For example, because a length of an antenna element may be dependent on the wavelength of the intended signal, the elongated shape of the second portion 110 may provide flexibility in the design of the antenna 106. Furthermore, because the antenna 106 may be extended away from the casing 202 of the electronic device 200 when mounted inside the second portion 110, signal interference on the antenna 106 may be reduced and the performance of the antenna 106 may thus be improved. In some examples, the second portion 110 may be formed of a material such as a plastic, a polymer, a glass, and/or the like, which may reduce or prevent interference of transmissions through the casing of the second portion 110.

The second portion 110 may include a joint 210, by which the first portion 108 and the second portion 110 may be rotatably coupled. In some examples, the joint 210 may include a pin (not shown) that extends through holes (not shown) formed through the second portion 110 and the first portion 108. It should be understood that other types of connection interfaces may be used for the joint 210 without departing from the scope of the joint 210.

In some examples, the joint 210 may facilitate rotation of the second portion 110 relative to the first portion 108 in a direction denoted by the arrow 212. In a particular example, the pin may extend in a lateral direction across the first and second portions 108 and 110 to couple the first portion 108 to the second portion 110. The second portion 110 may rotate about an axis that extends along the pin and the axis of rotation associated with direction 212 may be perpendicular to the axis of rotation associated with the direction 206 for rotation of the first portion 108.

In some examples, a section of the second portion 110 that is adjacent to the joint 210 may be shaped to facilitate rotation of the second portion 110. In particular examples, a recess 218 or cutout may be formed at a distal end of the second portion 110. The recess 218 may prevent contact between the first portion 108 and the second portion 110 to extend the range of rotation of the second portion 110 in the directions of the arrow 212.

The apparatus 100 may include the camera 104 disposed in the housing assembly 102. The camera 104 may be disposed inside the cavity formed in the second portion 110 of the housing assembly 102. A lens of the camera 104 may be disposed at an opening 208 formed through the second portion 110. As previously described, the camera 104 may be disposed toward an end of the second portion 110 of the housing assembly 102 to facilitate greater range of motion and flexibility in positioning the camera 104.

In some examples, the camera 104 may be a 3D camera. In a particular example, the 3D camera may include two or more lenses that may allow the 3D camera to simulate binocular vision and capture 3D images. In some examples, the housing assembly 102 may include a second opening 208 for a second lens of the camera 104. The second lens may be positioned at a predefined distance from the first lens to facilitate stereoscopic image capture.

In some examples, two separate cameras 104 may be mounted inside a single housing assembly 102 to facilitate 3D image capture. A first camera 104 and a second camera (not shown) may be disposed inside the cavity formed in the second portion 110. The first camera 104 and the second camera may be disposed at a predefined distance from each other to facilitate stereoscopic image disparity. For example, the first camera 104 may be disposed at an upper end of the second portion 110 and the second camera may be disposed at a lower end of the second portion 110, toward the joint 210.

In some examples, the electronic device 200 may include multiple apparatuses 100 to facilitate partial 3D rendering of an object. For example, in 3D image processing, multiple cameras may capture images of the same object from different perspectives and use the multiple images to create a partial 3D representation of the object. In this case, increased distance between the cameras may facilitate a more accurate partial 3D representation of an object. In a particular example, a second apparatus 214 (shown in FIG. 2A) may be mounted on the casing 202 of the electronic device 200. According to examples, the second apparatus 214 may be disposed at an opposite end of the casing 202 relative to the apparatus 100 in order to maximize a distance between respective cameras 104 housed in the apparatus 100 and the second apparatus 214.

In some examples, the cameras 104 may automatically be rotated to track a movement of an object during image capture. In particular examples, the apparatus 100 may include a mechanism (not shown) to enable automatic rotation of the respective housing assemblies 102, such as actuators, motors, controllers, or the like. The second apparatus 214 may include the same features as the first apparatus 100 described herein, and thus duplicative description of the common features is omitted herein.

The apparatus 100 may include the antenna 106 in the housing assembly 102. The antenna 106 may be a radio frequency (RF) antenna and may be implemented for various types of applications, such as, as a Wi-Fi antenna, a cellular antenna, or the like. The antenna 106 may be tuned to operate in specific frequencies based on the intended implementation. In some examples, the antenna 106 may be a metal film or sheet that is tuned for a specific frequency. The antenna 106 may be disposed on an inner surface of the second portion 110 inside the cavity of the second portion 110. Alternatively, or in addition, the antenna 106 may be disposed on a surface of a printed circuit board (PCB) disposed within the cavity of the second portion 110. For instance, the antenna 106 may be laminated on the inner surface or the PCB. Furthermore, a length of the antenna 106 may be dependent on a wavelength of the intended RF signal. Accordingly, in some examples the antenna 106 may be disposed to extend lengthwise along a length of the second portion 110 of the housing assembly 102.

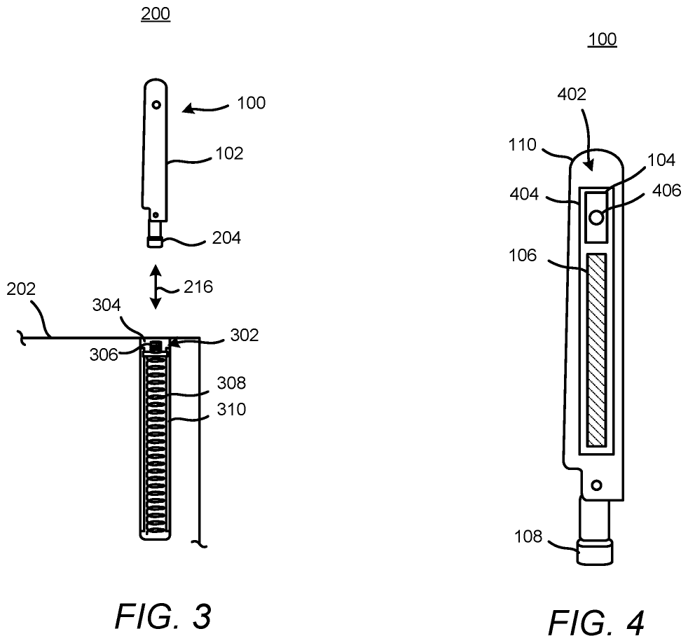

In some examples, the apparatus 100 may be moveable into the electronic device 200. That is, for instance, the apparatus 100 may be inserted into a recess (shown in FIG. 3) in the casing 202 of the electronic device 200 to be concealed when not in use. For example, the apparatus 100 may be moved into the casing 202, as denoted by the arrow 216, and concealed within the casing 202. In these examples, the casing 202 may have a recess to accommodate the housing assembly 102. In addition, when the housing assembly 102 is inserted into the recess of the casing 202, an upper surface of the second portion 110 may be flush or substantially flush with a surface of the casing 202.

In some examples, the apparatus 100 may be partially extended from the recess rather than being fully extended out of the recess, e.g., to expose the opening 208 for the camera 104. Furthermore, the antenna 106 may be operable even when the apparatus 100 is concealed within the casing 202 of the electronic device 200 or when partially extended. When the apparatus 100 is fully extended from the electronic device 200, the housing assembly 102 may be rotated in any of the manners described herein to adjust a position of the antenna 106, which may improve the performance of the antenna 106.

Reference is now made to FIG. 3, which shows an enlarged cross-sectional view of a portion of the example electronic device 200 depicted in FIG. 2A. As shown in FIG. 3, the apparatus 100 may include a third portion 302 to facilitate movement of the apparatus 100 into a recess 304 formed in the casing 202 of the electronic device 200. In some examples, the third portion 302 may be slideably coupled to the electronic device 200, e.g., within the recess 304. For example, the third portion 302 may include a connector 306, an elastic member 308, and a guide 310 to facilitate movement of the third portion 302.

The connector 306 may be removably coupled to the connector 204 on the first portion 108 of the housing assembly 102. In a particular example, the connector 306 may be a male screw-type connector having threads and the connector 204 on the first portion 108 may be a female screw-type connector, or vice versa. It should be understood that the connector 306 may be another appropriate type of connector based on the implementation.

In some examples, the elastic member 308 may be a spring, or the like. The elastic member 308 may extend a length of the recess 304 in a direction corresponding to the movement of the housing assembly 102 as denoted by the arrow 216. The elastic member 308 may exert a force in an upward direction 216 to move the housing assembly 102 out of the casing 202.

The guide 310 may be disposed along a length of the recess 304 and may guide movement of the connector 306 along the recess 304. In some examples, the connector 306 may be coupled to the elastic member 308, and a base of the connector 306 may be slideably coupled to the guide 310. In some examples, the guide 310 may be a rail, or the like.

In some examples, as the housing assembly 102 is pressed into the recess 304, the elastic member 308 may exert a resistive force against the movement, which may provide a tactile feedback for the user. As the housing assembly 102 is further inserted into the recess 304, the connector 306 may slide against the guides 310 and the elastic member 308 may be compressed. Once the housing assembly 102 is fully inserted into the recess 304, a latch (not shown), or the like, may hold the position of the housing assembly 102 in the recess 304. When the housing assembly 102 is fully inserted into the recess 304, an upper surface of the housing assembly 102 may be flush or nearly flush with a surface of the casing 202. In some examples, the housing assembly 102 may be released by pressing the housing assembly 102 again to release the latch. Once the latch is released, the elastic member 308 may exert a force to extend the housing assembly 102 out of the casing 202.

While the third portion 302 is described herein as including the elastic member 308 and guides 310 to guide the slideable movement of the third portion 302, it should be understood that other mechanisms may be used to guide movement of the housing assembly 102 into and out of the recess 304 without departing from the scope of the present disclosure. For example, in some examples, the third portion 302 may include a motor or actuators to automatically move the housing assembly 102 into and out of the recess 304.

Reference is now made to FIG. 4, which shows a cross-sectional view of the example apparatus 100 depicted in FIGS. 1, 2A, and 2B. As shown, the second portion 110 of the housing assembly 102 may have a cavity 402 to accommodate the camera 104 and the antenna 106. In some examples, the camera 104 and the antenna 106 may be mounted on a PCB 404. The camera 104 may be mounted on a surface of the PCB 404 and the PCB 404 may be positioned such that a lens 406 of the camera 104 may be disposed at or through the opening 208 formed through the casing of the second portion 110. In some examples as previously described, multiple cameras 104 may be disposed on the PCB 404.

In some examples, the antenna 106 may be disposed on the PCB 404. The antenna 106 may be a metal film, or the like, and may be formed using traces during manufacture of the PCB 404. In some examples, the antenna 106 may be laminated on the surface of the PCB 404. Alternatively, or in addition, the antenna 106 may be laminated on an inner surface of the second portion 110, inside the cavity 402.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a housing assembly that includes:
a first portion to be rotatably coupled to an electronic device; and
a second portion rotatably coupled to the first portion, the second portion having a columnar shape and a cavity formed in the second portion;
a camera disposed in the cavity formed in the second portion of the housing assembly; and
an antenna disposed in the cavity formed in the second portion of the housing assembly.

2. The apparatus of claim 1, wherein the first portion of the housing assembly is to extend from the electronic device in a first direction along a first axis, and
wherein the first portion is rotatable about the first axis and the second portion is rotatable relative to the first portion about a second axis, the second axis being perpendicular to the first axis.

3. The apparatus of claim 2, wherein the housing assembly includes a joint to connect the first portion to the second portion, and wherein the second portion is rotatably coupled to the first portion at the joint.

4. The apparatus of claim 2, further comprising:
a third portion that is to be slideably coupled to the electronic device to move along the first axis, wherein the third portion is coupled to the first portion, and wherein the housing assembly is to be inserted into a recess in the electronic device and to be removed from the recess through slideable movement of the third portion.

5. The apparatus of claim 1, wherein the second portion has an upper surface and wherein the housing assembly is to be fully inserted into a recess in the electronic device, and wherein when the housing assembly is fully inserted into the recess, the upper surface is flush or nearly flush with a surface of the electronic device.

6. The apparatus of claim 1, wherein the housing assembly includes a connector coupled to the first portion of the housing assembly, the housing assembly to be removeably coupled to the electronic device via the connector.

7. The apparatus of claim 1, wherein the second portion of the housing assembly includes an opening formed through a surface of the second portion, and wherein a lens of the camera is disposed at the opening.

8. The apparatus of claim 1, wherein the antenna is a metal film that is disposed on an inner surface of the cavity formed in the second portion of the housing assembly.

9. The apparatus of claim 1, further comprising a circuit board disposed in the cavity, wherein the antenna and the camera are disposed on the circuit board.

10. An electronic device comprising:
a body having a recess; and
an assembly moveably disposed in the recess of the body, the assembly comprising:
a base having a connector, the base being rotatably coupled to the body via the connector;
an enclosure rotatably coupled to the base, the enclosure having an elongated shape and a cavity formed inside the enclosure;
a camera disposed in the cavity of the enclosure; and
an antenna disposed in the cavity of the enclosure.

11. The electronic device of claim 10, wherein the assembly is to be inserted into the recess of the body in a first direction along a first axis, wherein the assembly is rotatable relative to the body about the first axis, and wherein the enclosure is rotatable relative to the body about a second axis, the second axis being perpendicular to the first axis.

12. The electronic device of claim 10, wherein an outer surface of the enclosure has a tubular shape, and the camera is disposed at an opening formed on a lateral surface of the outer surface.

13. The electronic device of claim 10, further comprising a second assembly, wherein the assembly is disposed at a first end of the body and the second assembly is disposed at a second end of the body, the second end being opposite the first end of the body, the second assembly including:
a second base having a second connector, the second base being rotatably coupled to the body via the second connector;
a second enclosure rotatably coupled to the base, the second enclosure having an elongated shape and a second cavity formed inside the second enclosure;
a second camera disposed in the second cavity of the second enclosure; and
a second antenna disposed in the second cavity of the second enclosure.

14. A housing assembly comprising:
a first portion;
a second portion rotatably coupled to the first portion, the second portion having a columnar shape and a cavity formed in the second portion;
a camera disposed in the cavity of the second portion; and
an antenna disposed in the cavity of the second portion,
wherein the first portion is to rotate about a first axis, the second portion is to rotate about a second axis, the second axis being perpendicular to the first axis, and wherein the first portion and the second portion are to be inserted into a housing of an electronic device to conceal the housing assembly within the electronic device.

15. The housing assembly of claim 14, wherein the antenna is a metal film disposed on an inner surface of the cavity of the second portion.
